(19) United States
(12) Patent Application Publication
(10) Pub. No.: US 2026/0287725 A1
(43) Pub. Date: Sep. 24, 2026

(54) SYSTEMS AND METHODS FOR UWB MULTI-STATIC RADAR

(71) Applicants: Kurt Thomas SOTO, Santa Barbara, CA (US); Emily Anne MADDEN, Santa Barbara, CA (US); Iam FRANK, Santa Barbara, CA (US); Ian FRANK, Santa Barbara, CA (US); Sonos, Inc., Goleta, CA (US)

(72) Inventors: Kurt Thomas Soto, Santa Barbara, CA (US); Ian Frank, Arlington, MA (US); Emily Anne Madden, Santa Barbara, CA (US)

(21) Appl. No.: 18/874,295

(22) PCT Filed: Jun. 13, 2023
(86) PCT No.: PCT/US2023/068370

§ 371 Date: Dec. 12, 2024

Related U.S. Application Data
(60) Provisional application No. 63/366,327, filed on Jun. 13, 2022.

(51) Int. Cl. G01S 13/00; G01S 7/41; G01S 13/02; G01S 13/46; H04R 3/12; H04R 27/00

(52) U.S. Cl. CPC G01S 13/003; G01S 7/418; G01S 13/0209; G01S 13/46; G01S 2013/468; H04R 3/12; H04R 27/00

(57) ABSTRACT

Systems and methods for ultra-wideband multi-static radar are illustrated. One embodiment includes a method for determining the localization of an object based on deviation from baseline impulse responses. The method includes steps for comparing subsequent impulse responses to the baseline impulse responses and detecting the degree to which the subsequent impulse responses deviate from the baseline impulse responses.

### CROSS-REFERENCE TO RELATED APPLICATIONS

The current application claims the benefit of and priority under 35 U.S.C. §119(e) to U.S. Provisional Patent Application Ser. No. 63/366,327 entitled “Systems and Methods for UWB Multi-Static Radar,” filed Jun. 13, 2022, which is incorporated herein by reference in its entirety for all purposes.

### FIELD OF THE INVENTION

The present invention generally relates to methods, systems, products, features, services, and other elements directed to localization through the use of ultra-wideband multi-static radar within media playback systems.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The SONOS Wireless HiFi System enables people to experience music from many sources via one or more networked playback devices. Through a software control application installed on a smartphone, tablet, or computer, one can play what he or she wants in any room that has a networked playback device. Additionally, using a controller, for example, different songs can be streamed to each room that has a playback device, rooms can be grouped together for synchronous playback, or the same song can be heard in all rooms synchronously.

Given the ever-growing interest in digital media, there continues to be a need to develop consumer-accessible technologies to further enhance the listening experience.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIGS. 3A-3E are diagrams showing example playback device configurations in accordance with aspects of the disclosure.

FIG. 4A is a functional block diagram of an example controller device in accordance with aspects of the disclosure.

FIGS. 4B and 4C are controller interfaces in accordance with aspects of the disclosure.

FIG. 5 is a functional block diagram of certain components of an example network microphone device in accordance with aspects of the disclosure.

FIG. 6A is a diagram of an example voice input.

FIG. 6B is a graph depicting an example sound specimen in accordance with aspects of the disclosure.

FIG. 7 conceptually illustrates a process for determining the localization data for an object in an area operating in accordance with an embodiment of the invention.

FIG. 8 is a singular Channel Impulse Response (CIR) magnitude measurement for a system operating in accordance with aspects of the disclosure at three points in time: before, during, and after the introduction of an object.

FIG. 9 illustrates a step-by-step process for interpreting CIR measurements in order to localize an object in an area operating in accordance with an embodiment of the invention.

FIG. 10A shows adjacent graphs depicting accumulated CIR magnitude measurements for an area operating in accordance with aspects of the disclosure.

FIGS. 10B-10D shows graphs depicting accumulated CIR phase measurements for an area operating in accordance with aspects of the disclosure.

FIG. 11 is a depiction of an accumulation of CIR magnitude measurements, wherein an object has been introduced in an area operating in accordance with aspects of the disclosure and a superimposed arrow represents an inference of the object's movement over time.

FIG. 12 is a sample floorplan, incorporating several pairs of nodes, each forming an ellipsoid representative of estimates of positioning for an introduced object.

FIG. 13 is a depiction of an accumulation of CIR magnitude measurement residuals, wherein an object has been introduced in an area operating in accordance with aspects of the disclosure and a series of arrows depict inferences of the object's distance from two nodes, respectively, at four separate periods.

FIG. 14A is a sample floorplan, incorporating six different nodes, for an area operating in accordance with aspects of the disclosure, and in which a sample object's motion through the area at different points is represented by a series of arrows.

FIGS. 14B-14F are depictions of multiple accumulations of CIR magnitude measurement residuals for the area disclosed in FIG. 14A, and on which superimposed arrows depict respective inferences of the object's distance relative to multiple combinations of nodes.

FIGS. 14G-14H illustrate the parity of CIR measurements between a pair of nodes.

FIG. 15 is a representation of the data received by each of four nodes when a singular signal is transmitted in an area operating in accordance with aspects of the disclosure.

### DETAILED DESCRIPTION

### 1. Overview

Systems and methods in accordance with numerous embodiments can localize individuals in a region between devices. Most conventional wireless-based location determination techniques rely on standard Received Signal Strength Indicator measurements associated with packet transmissions in a given wireless channel. One problem with such a conventional approach is that the wide wireless channels (e.g., 500+ MHz wide) can have limited accuracy in a localization context. Accordingly, aspects of the present disclosure relate to new techniques for using multi-static processes to refine ultra-wideband localization. Instead of attempting to determine location based on individual measurements, processes in accordance with various embodiments can benefit from spatially diverse components and, as such, substantially expand the area of coverage.

In many embodiments, new experiences can be enabled and customized based on some indication of where a user is located relative to different devices. For example, systems and methods in accordance with some embodiments can adjust audio characteristics, or variables, (e.g., volume, balance, etc.) based on a user's location in the area between the playback devices such that the user is always in an acoustic sweet spot. In a number of embodiments, such features can be enabled without incorporating any additional hardware within the playback devices or the home theater system. Systems and methods in accordance with certain embodiments can leverage existing wireless radios in various devices to detect user location. In accordance with some embodiments of the invention, a wireless radio may include a transmitter, a receiver, an antenna, and/or a power supply.

It should be appreciated that the techniques described herein may be employed to detect more than a location of a user relative to one or more devices. For example, such techniques may be employed to detect gestures performed by a user within a region (e.g., on a couch in a home theater setup). Examples of such gestures that may be detected using channel state information include: sitting down, standing up, walking, nodding head, shaking head, waving hand(s), and raising hand(s). Through detection of such gestures, systems in accordance with embodiments described here may advantageously provide an additional control mechanism through which a user may control one or more aspects of the system.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

### II. Example Operating Environment

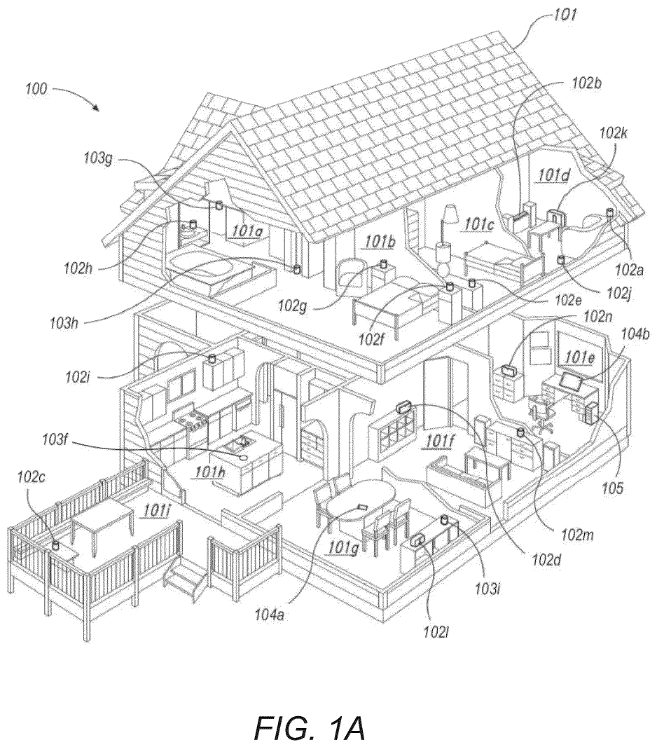

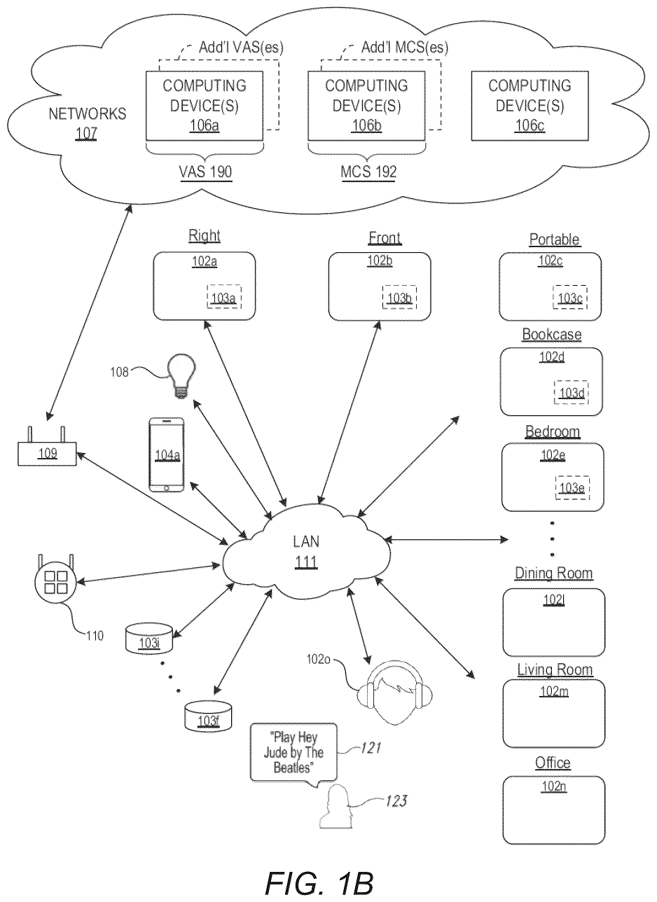

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 includes a household having several rooms, spaces, and/or playback zones, including a master bathroom 101a, a master bedroom 101b (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-103i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A). In embodiments described below, one or more of the various playback devices 102 may be configured as portable playback devices, while others may be configured as stationary playback devices. For example, the headphones 1020 (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like. Localization, prediction, and/or training of prediction models in accordance with a number of embodiments can be performed on such computing devices.

With reference still to FIG. 1B, the various playback, network microphone, and controller devices 102-104 and/or other network devices of the MPS 100 may be coupled to one another via point-to-point connections and/or over other connections, which may be wired and/or wireless, via a LAN 111 including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the LAN 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a voice activated system (“VAS”) and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems. Remote computing devices can be used for parts of localization, prediction, and/or training of prediction models in accordance with a number of embodiments.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the LAN 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the media playback system 100 may exchange data via communication paths as described herein and/or using a metadata exchange channel as described in U.S. Application Publication No. US-2017-0242653, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. Application Publication No. US-2017-0242653.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Application Publication No. US-2017-0242653.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the LAN 111 (FIG. 1B) may be eliminated and the single playback device 102 and/or the single NMD 103 may communicate directly with the remote computing devices 106a-d. In some embodiments, a telecommunication network (e.g., an LTE network, a 5G network, etc.) may communicate with the various playback, network microphone, and/or controller devices 102-104 independent of a LAN.

While specific implementations of MPS's have been described above with respect to FIGS. 1A and 1B, there are numerous configurations of MPS's, including, but not limited to, those that do not interact with remote services, systems that do not include controllers, and/or any other configuration as appropriate to the requirements of a given application.

### 1. Example Playback & Network Microphone Devices

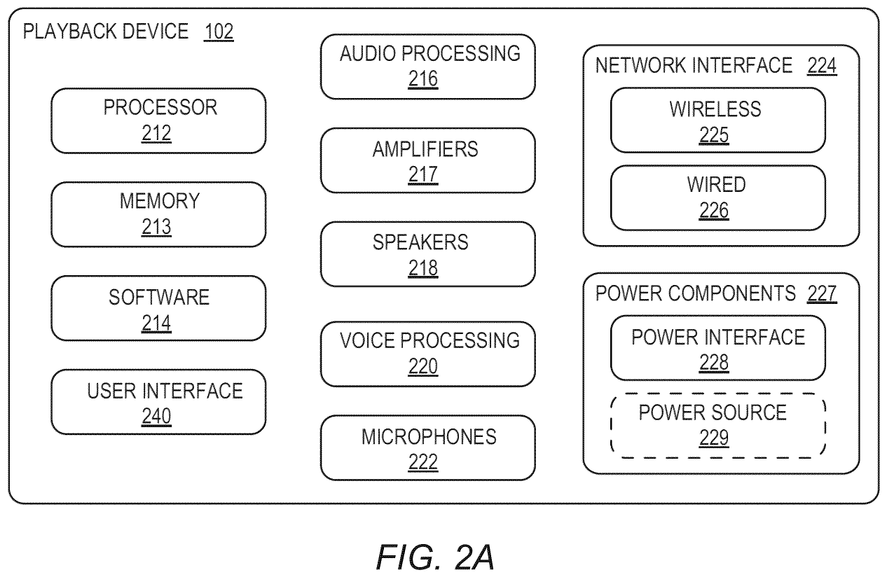

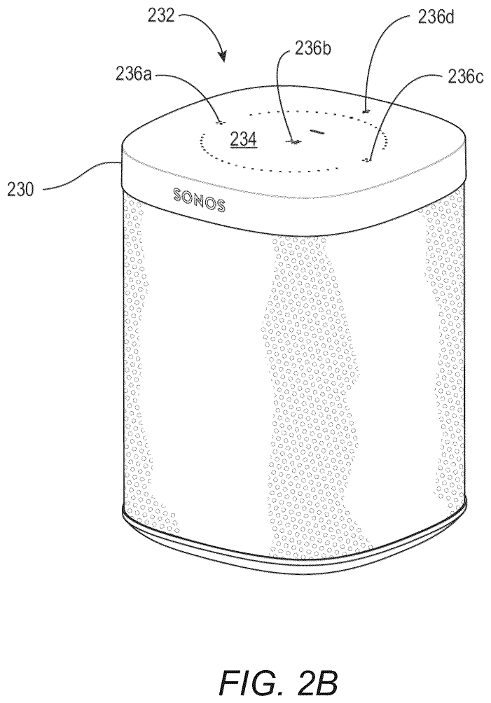

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in previously-referenced U.S. Application Publication No. US-2017-0242653.

As further shown in FIG. 2A, the playback device 102 also includes power components 227. The power components 227 can include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 can further include a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

While specific implementations of playback and network microphone devices have been described above with respect to FIGS. 2A and 2B, there are numerous configurations of devices, including, but not limited to, those having no UI, microphones in different locations, multiple microphone arrays positioned in different arrangements, and/or any other configuration as appropriate to the requirements of a given application. For example, Uls and/or microphone arrays can be implemented in other playback devices and/or computing devices rather than those described herein. Further, although a specific example of playback device 102 is described with reference to MPS 100, one skilled in the art will recognize that playback devices as described herein can be used in a variety of different environments, including (but not limited to) environments with more and/or fewer elements, without departing from the scope of the present disclosure. Likewise, MPS's as described herein can be used with various different playback devices.

By way of illustration, SONOS, Inc. presently offers (or has offered) for sale certain playback devices that may implement certain of the embodiments disclosed herein, including a “PLAY: 1,” “PLAY: 3,” “PLAY: 5,” “PLAYBAR,” “CONNECT:AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the media playback system 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

### 2. Example Playback Device Configurations

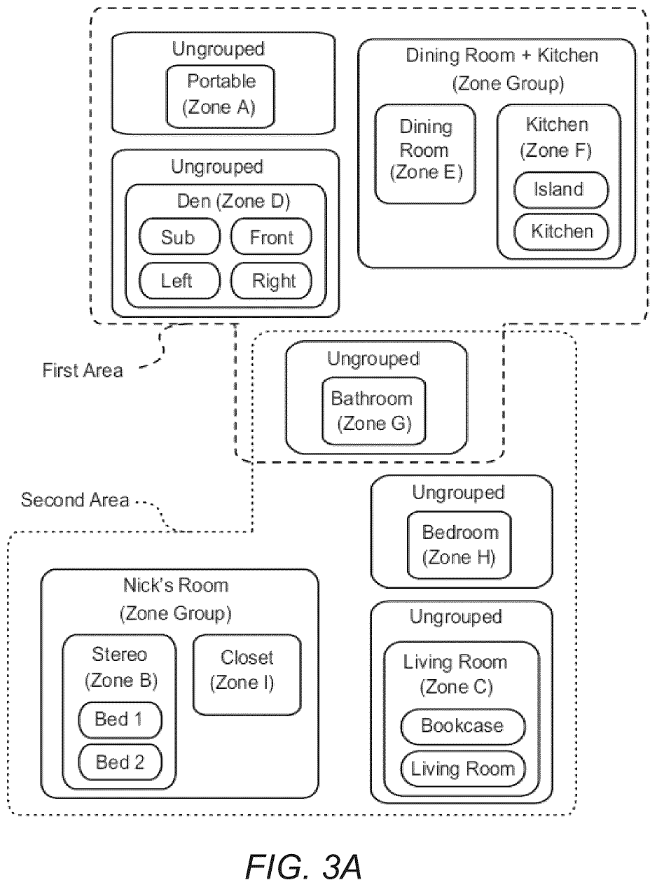

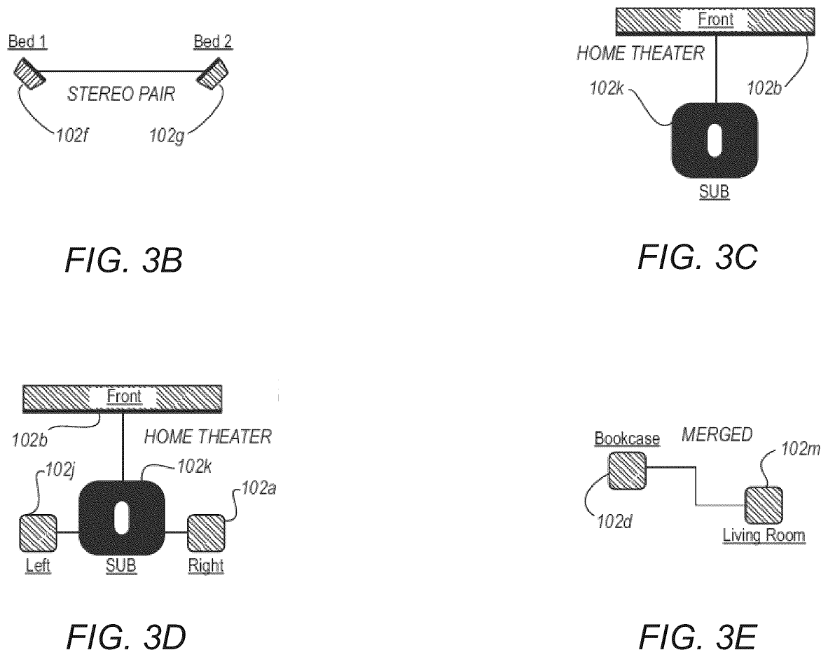

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101b (FIG. 1A) and the Bed 2 device may be the playback device 102g also in the master bedroom 101b (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. Application Publication No. US-2017-0242653. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that NMD 103f and playback device 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### 3. Example Controller Devices

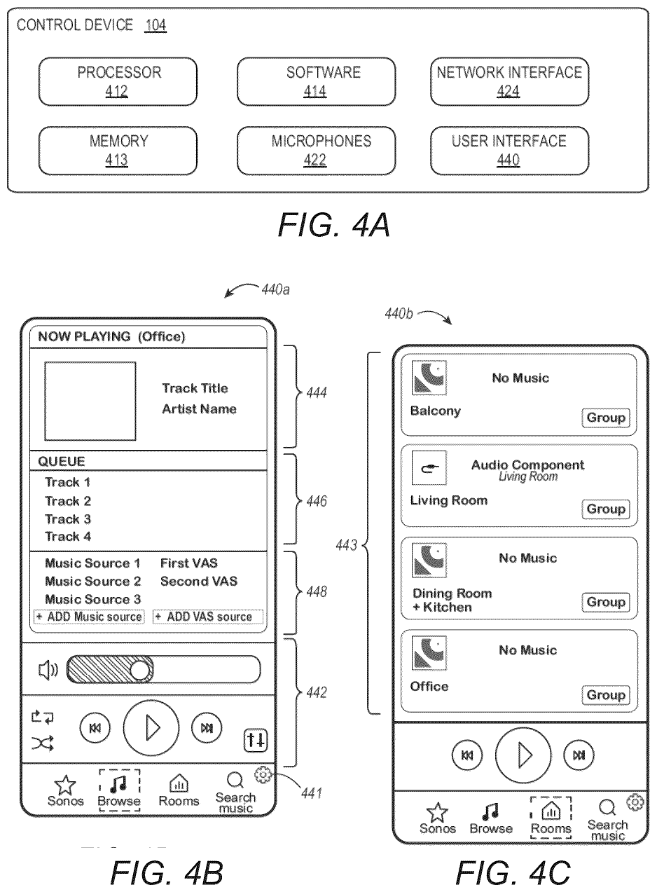

FIG. 4A is a functional block diagram illustrating certain aspects of a selected one of the controller devices 104 of the MPS 100 of FIG. 1A. Controller devices in accordance with several embodiments can be used in various systems, such as (but not limited to) an MPS as described in FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the MPS 100. The memory 413 may be loaded with instructions in software 414 that are executable by the processor 412 to achieve certain functions, such as facilitating user access, control, and/or configuration of the MPS 100. The controller device 104 can be configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4A, the controller device 104 can also include a user interface 440 that is generally configured to facilitate user access and control of the MPS 100. The user interface 440 may include a touch-screen display or other physical interface configured to provide various graphical controller interfaces, such as the controller interfaces 440a and 440b shown in FIGS. 4B and 4C. Referring to FIGS. 4B and 4C together, the controller interfaces 440a and 440b include a playback control region 442, a playback zone region 443, a playback status region 444, a playback queue region 446, and a sources region 448. The user interface as shown is just one example of an interface that may be provided on a network device, such as the controller device shown in FIG. 4A, and accessed by users to control a media playback system, such as the MPS 100. Other user interfaces of varying formats, styles, and interactive sequences may alternatively be implemented on one or more network devices to provide comparable control access to a media playback system.

The playback control region 442 (FIG. 4B) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 442 may also include selectable icons that, when selected, modify equalization settings and/or playback volume, among other possibilities.

The playback zone region 443 (FIG. 4C) may include representations of playback zones within the MPS 100. The playback zones regions 443 may also include a representation of zone groups, such as the Dining Room+Kitchen zone group, as shown. In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 443 (FIG. 4C) may be dynamically updated as playback zone or zone group configurations are modified.

The playback status region 444 (FIG. 4B) may include graphical representations of audio content that is presently being played, previously played, or scheduled to play next in the selected playback zone or zone group. The selected playback zone or zone group may be visually distinguished on a controller interface, such as within the playback zone region 443 and/or the playback status region 444. The graphical representations may include track title, artist name, album name, album year, track length, and/or other relevant information that may be useful for the user to know when controlling the MPS 100 via a controller interface.

The playback queue region 446 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may include a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 4B and 4C, the graphical representations of audio content in the playback queue region 446 (FIG. 4B) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 448 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to the NMD 103i in the Dining Room 101g shown in FIG. 1A, and a second VAS to the NMD 103f in the Kitchen. Other examples are possible.

### 4. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments, audio content may be provided by one or more media content services.

Example audio content sources may include a memory of one or more playback devices in a media playback system such as the MPS 100 of FIG. 1A, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

### 5. Example Network Microphone Devices

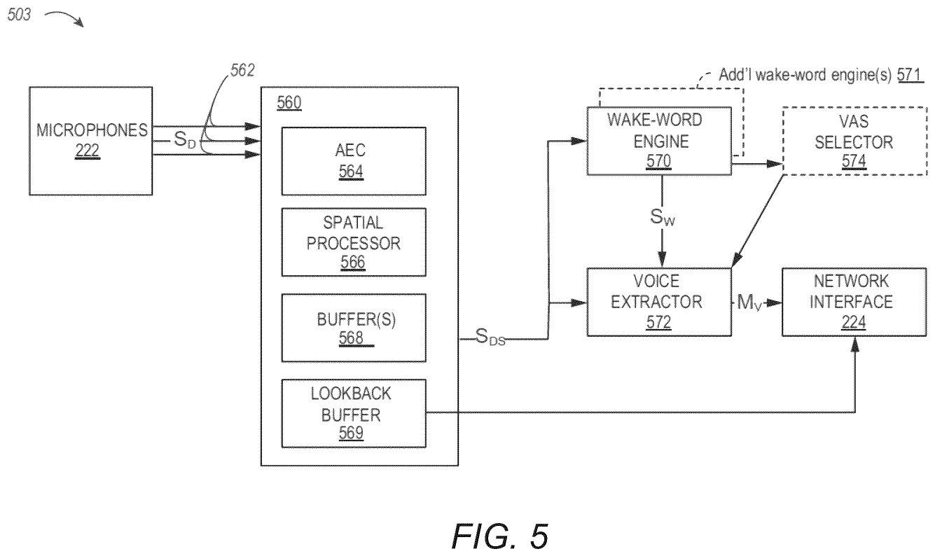

FIG. 5 is a functional block diagram showing an NMD 503 configured in accordance with embodiments of the disclosure. The NMD 503 includes voice capture components (“VCC”, or collectively “voice processor 560”), a wake-word engine 570, and at least one voice extractor 572, each of which can be operably coupled to the voice processor 560. The NMD 503 further includes the microphones 222 and the at least one network interface 224 described above and may also include other components, such as audio amplifiers, interface, etc., which are not shown in FIG. 5 for purposes of clarity.

The microphones 222 of the NMD 503 can be configured to provide detected sound, S_{D}, from the environment of the NMD 503 to the voice processor 560. The detected sound S_{D} may take the form of one or more analog or digital signals. In example implementations, the detected sound S_{D} may be composed of a plurality of signals associated with respective channels 562 that are fed to the voice processor 560.

Each channel 562 may correspond to a particular microphone 222. For example, an NMD having six microphones may have six corresponding channels. Each channel of the detected sound S_{D} may bear certain similarities to the other channels but may differ in certain regards, which may be due to the position of the given channel's corresponding microphone relative to the microphones of other channels. For example, one or more of the channels of the detected sound S_{D} may have a greater signal to noise ratio (“SNR”) of speech to background noise than other channels.

As further shown in FIG. 5, the voice processor 560 includes an AEC 564, a spatial processor 566, and one or more buffers 568. In operation, the AEC 564 receives the detected sound S_{D} and filters or otherwise processes the sound to suppress echoes and/or to otherwise improve the quality of the detected sound S_{D}. That processed sound may then be passed to the spatial processor 566.

The spatial processor 566 is typically configured to analyze the detected sound Sp and identify certain characteristics, such as a sound's amplitude (e.g., decibel level), frequency spectrum, directionality, etc. In one respect, the spatial processor 566 may help filter or suppress ambient noise in the detected sound Sp from potential user speech based on similarities and differences in the constituent channels 562 of the detected sound S_{D}, as discussed above. As one possibility, the spatial processor 566 may monitor metrics that distinguish speech from other sounds. Such metrics can include, for example, energy within the speech band relative to background noise and entropy within the speech band—a measure of spectral structure—which is typically lower in speech than in most common background noise. In some implementations, the spatial processor 566 may be configured to determine a speech presence probability, examples of such functionality are disclosed in U.S. patent application Ser. No. 15/984,073, filed May 18, 2018, titled “Linear Filtering for Noise-Suppressed Speech Detection,” and U.S. patent application Ser. No. 16/147,710, filed Sep. 29, 2018, and titled “Linear Filtering for Noise-Suppressed Speech Detection via Multiple Network Microphone Devices,” each of which is incorporated herein by reference in its entirety.

The wake-word engine 570 can be configured to monitor and analyze received audio to determine if any wake words are present in the audio. The wake-word engine 570 may analyze the received audio using a wake word detection algorithm. If the wake-word engine 570 detects a wake word, a network microphone device may process voice input contained in the received audio. Example wake word detection algorithms accept audio as input and provide an indication of whether a wake word is present in the audio. Many first- and third-party wake word detection processes are known and commercially available. For instance, operators of a voice service may make their processes available for use in third-party devices. Alternatively, a process may be trained to detect certain wake-words.

In some embodiments, the wake-word engine 570 runs multiple wake word detection processes on the received audio simultaneously (or substantially simultaneously). As noted above, different voice services (e.g. AMAZON's Alexa®, APPLE's Siri®, MICROSOFT's Cortana®, GOOGLE'S Assistant, etc.) each use a different wake word for invoking their respective voice service. To support multiple services, the wake-word engine 570 may run the received audio through the wake word detection process for each supported voice service in parallel. In such embodiments, the network microphone device 103 may include VAS selector 574 with components configured to pass voice input to the appropriate voice assistant service. In other embodiments, the VAS selector components 574 may be omitted. In some embodiments, individual NMDs 103 of the MPS 100 may be configured to run different wake word detection processes associated with particular VASes. For example, the NMDs of playback devices 102a and 102b of the Living Room may be associated with AMAZON's ALEXA®, and be configured to run a corresponding wake word detection process (e.g., configured to detect the wake word “Alexa” or other associated wake word), while the NMD of playback device 102f in the Kitchen may be associated with GOOGLE's Assistant, and be configured to run a corresponding wake word detection process (e.g., configured to detect the wake word “OK, Google” or other associated wake word).

In some embodiments, a network microphone device may include speech processing components configured to further facilitate voice processing, such as by performing voice recognition trained to recognize a particular user or a particular set of users associated with a household. Voice recognition software may implement processes that are tuned to specific voice profile(s).

In operation, the one or more buffers 568—or more of which may be part of or separate from the memory 213 (FIG. 2A)—capture data corresponding to the detected sound S_{D}. More specifically, the one or more buffers 568 capture detected-sound data that was processed by the upstream AEC 564 and spatial processor 566.

In general, the detected-sound data form a digital representation (i.e., sound-data stream), S_{DS}, of the sound detected by the microphones 222. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers 568 for further processing by downstream components, such as the wake-word engine 570 and the voice extractor 572 of the NMD 503.

In some implementations, at least one buffer 568 captures detected-sound data utilizing a sliding window approach in which a given amount (i.e., a given window) of the most recently captured detected-sound data is retained in the at least one buffer 568 while older detected-sound data are overwritten when they fall outside of the window. For example, at least one buffer 568 may temporarily retain 20 frames of a sound specimen at given time, discard the oldest frame after an expiration time, and then capture a new frame, which is added to the 19 prior frames of the sound specimen.

In practice, when the sound-data stream S_{DS} is composed of frames, the frames may take a variety of forms having a variety of characteristics. As one possibility, the frames may take the form of audio frames that have a certain resolution (e.g., 16 bits of resolution), which may be based on a sampling rate (e.g., 44, 100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen, among other examples. Thus, in some embodiments, a frame may include a portion of sound (e.g., one or more samples of a given sound specimen) and metadata regarding the portion of sound. In other embodiments, a frame may only include a portion of sound (e.g., one or more samples of a given sound specimen) or metadata regarding a portion of sound.

The voice processor 560 can also include at least one lookback buffer 569, which may be part of or separate from the memory 213 (FIG. 2A). In operation, the lookback buffer 569 can store sound metadata that is processed based on the detected-sound data S_{D} received from the microphones 222. As noted above, the microphones 222 can include a plurality of microphones arranged in an array. The sound metadata can include, for example: (1) frequency response data for individual microphones of the array, (2) an echo return loss enhancement measure (i.e., a measure of the effectiveness of the acoustic echo canceller (AEC) for each microphone), (3) a voice direction measure; (4) arbitration statistics (e.g., signal and noise estimates for the spatial processing streams associated with different microphones); and/or (5) speech spectral data (i.e., frequency response evaluated on processed audio output after acoustic echo cancellation and spatial processing have been performed). Other sound metadata may also be used to identify and/or classify noise in the detected-sound data S_{D}. In at least some embodiments, the sound metadata may be transmitted separately from the sound-data stream S_{DS}, as reflected in the arrow extending from the lookback buffer 569 to the network interface 224. For example, the sound metadata may be transmitted from the lookback buffer 569 to one or more remote computing devices separate from the VAS which receives the sound-data stream S_{DS}. In some embodiments, for example, the metadata can be transmitted to a remote service provider for analysis to construct or modify a noise classifier, as described in more detail below.

In any case, components of the NMD 503 downstream of the voice processor 560 may process the sound-data stream S_{DS}. For instance, the wake-word engine 570 can be configured to apply one or more identification processes to the sound-data stream S_{DS} (e.g., streamed sound frames) to spot potential wake words in the detected-sound S_{D}. When the wake-word engine 570 spots a potential wake word, the wake-word engine 570 can provide an indication of a “wake-word event” (also referred to as a “wake-word trigger”) to the voice extractor 572 in the form of signal S_{W}.

In response to the wake-word event (e.g., in response to a signal S_{W} from the wake-word engine 570 indicating the wake-word event), the voice extractor 572 can be configured to receive and format (e.g., packetize) the sound-data stream S_{DS}. For instance, the voice extractor 572 packetizes the frames of the sound-data stream S_{DS} into messages. The voice extractor 572 can transmit or stream these messages, M_{V}, that may contain voice input in real time or near real time, to a remote VAS, such as the VAS 190 (FIG. 1B), via the network interface 224.

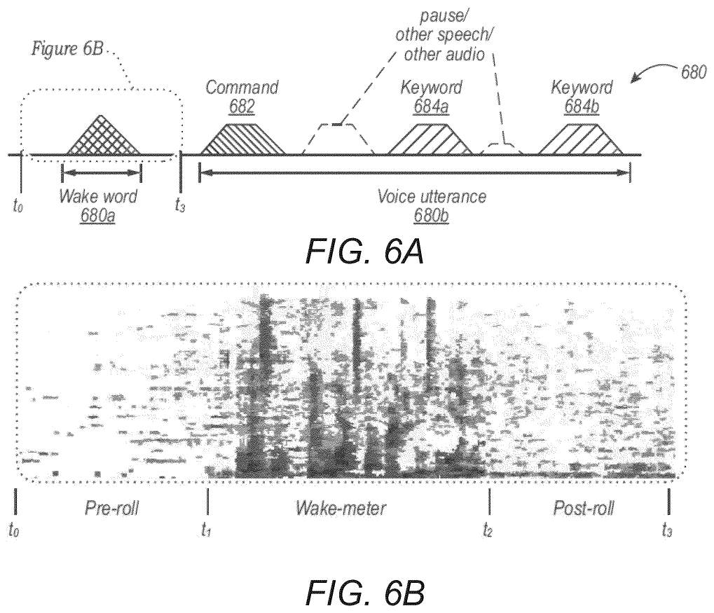

The VAS can be configured to process the sound-data stream S_{DS} contained in the messages M_{V} sent from the NMD 503. More specifically, the VAS can be configured to identify voice input based on the sound-data stream S_{DS}. Referring to FIG. 6A, a voice input 680 may include a wake-word portion 680a and an utterance portion 680b. The wake-word portion 680a can correspond to detected sound that caused the wake-word event. For instance, the wake-word portion 680a can correspond to detected sound that caused the wake-word engine 570 to provide an indication of a wake-word event to the voice extractor 572. The utterance portion 680b can correspond to detected sound that potentially includes a user request following the wake-word portion 680a.

As an illustrative example, FIG. 6B shows an example first sound specimen. In this example, the sound specimen corresponds to the sound-data stream S_{DS} (e.g., one or more audio frames) associated with the spotted wake word portion 680a of FIG. 6A. As illustrated, the example first sound specimen includes sound detected in the playback device 102i's environment (i) immediately before a wake word was spoken, which may be referred to as a pre-roll portion (between times t₀ and t₁), (ii) while the wake word was spoken, which may be referred to as a wake-meter portion (between times t₁ and t₂), and/or (iii) after the wake word was spoken, which may be referred to as a post-roll portion (between times t₂ and t₃). Other sound specimens are also possible.

Typically, the VAS may first process the wake-word portion 680a within the sound-data stream S_{DS} to verify the presence of the wake word. In some instances, the VAS may determine that the wake-word portion 680a includes a false wake word (e.g., the word “Election” when the word “Alexa” is the target wake word). In such an occurrence, the VAS may send a response to the NMD 503 (FIG. 5) with an indication for the NMD 503 to cease extraction of sound data, which may cause the voice extractor 572 to cease further streaming of the detected-sound data to the VAS. The wake-word engine 570 may resume or continue monitoring sound specimens until another potential wake word, leading to another wake-word event. In some implementations, the VAS may not process or receive the wake-word portion 680a but instead processes only the utterance portion 680b.

In any case, the VAS processes the utterance portion 680b to identify the presence of any words in the detected-sound data and to determine an underlying intent from these words. The words may correspond to a certain command and certain keywords 684 (identified individually in FIG. 6A as a first keyword 684a and a second keyword 684b). A keyword may be, for example, a word in the voice input 680 identifying a particular device or group in the MPS 100. For instance, in the illustrated example, the keywords 684 may be one or more words identifying one or more zones in which the music is to be played, such as the Living Room and the Dining Room (FIG. 1A).

To determine the intent of the words, the VAS is typically in communication with one or more databases associated with the VAS (not shown) and/or one or more databases (not shown) of the MPS 100. Such databases may store various user data, analytics, catalogs, and other information for natural language processing and/or other processing. In some implementations, such databases may be updated for adaptive learning and feedback for a neural network based on voice-input processing. In some cases, the utterance portion 680b may include additional information, such as detected pauses (e.g., periods of non-speech) between words spoken by a user, as shown in FIG. 6A. The pauses may demarcate the locations of separate commands, keywords, or other information spoke by the user within the utterance portion 680b.

Based on certain command criteria, the VAS may take actions as a result of identifying one or more commands in the voice input, such as the command 682. Command criteria may be based on the inclusion of certain keywords within the voice input, among other possibilities. Additionally, or alternatively, command criteria for commands may involve identification of one or more control-state and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

After processing the voice input, the VAS may send a response to the MPS 100 with an instruction to perform one or more actions based on an intent it determined from the voice input. For example, based on the voice input, the VAS may direct the MPS 100 to initiate playback on one or more of the playback devices 102, control one or more of these devices (e.g., raise/lower volume, group/ungroup devices, etc.), turn on/off certain smart devices, among other actions. After receiving the response from the VAS, the wake-word engine 570 the NMD 503 may resume or continue to monitor the sound-data stream S_{DS} until it spots another potential wake-word, as discussed above.

Referring back to FIG. 5, in multi-VAS implementations, the NMD 503 may include a VAS selector 574 (shown in dashed lines) that is generally configured to direct the voice extractor's extraction and transmission of the sound-data stream S_{DS} to the appropriate VAS when a given wake-word is identified by a particular wake-word engine, such as the first wake-word engine 570a, the second wake-word engine 570b, or the additional wake-word engine 571. In such implementations, the NMD 503 may include multiple, different wake-word engines and/or voice extractors, each supported by a particular VAS. Similar to the discussion above, each wake-word engine may be configured to receive as input the sound-data stream S_{DS} from the one or more buffers 568 and apply identification algorithms to cause a wake-word trigger for the appropriate VAS. Thus, as one example, the first wake-word engine 570a may be configured to identify the wake word “Alexa” and cause the NMD 503 to invoke the AMAZON VAS when “Alexa” is spotted. As another example, the second wake-word engine 570b may be configured to identify the wake word “Ok, Google” and cause the NMD 503 to invoke the GOOGLE VAS when “Ok, Google” is spotted. In single-VAS implementations, the VAS selector 574 may be omitted.

In additional or alternative implementations, the NMD 503 may include other voice-input identification engines 571 (shown in dashed lines) that enable the NMD 503 to operate without the assistance of a remote VAS. As an example, such an engine may identify in detected sound certain commands (e.g., “play,” “pause,” “turn on,” etc.) and/or certain keywords or phrases, such as the unique name assigned to a given playback device (e.g., “Bookcase,” “Patio,” “Office,” etc.). In response to identifying one or more of these commands, keywords, and/or phrases, the NMD 503 may communicate a signal (not shown in FIG. 5) that causes the audio processing components 216 (FIG. 2A) to perform one or more actions. For instance, when a user says “Hey Sonos, stop the music in the office,” the NMD 503 may communicate a signal to the office playback device 102n, either directly, or indirectly via one or more other devices of the MPS 100, which causes the office device 102n to stop audio playback. Reducing or eliminating the need for assistance from a remote VAS may reduce latency that might otherwise occur when processing voice input remotely. In some cases, the identification algorithms employed may be configured to identify commands that are spoken without a preceding wake word. For instance, in the example above, the NMD 503 may employ an identification algorithm that triggers an event to stop the music in the office without the user first saying “Hey Sonos” or another wake word.

### III. Object Detection Through Uwb Multi-static Radar

Systems and methods in accordance with numerous embodiments of the invention can integrate multi-static radar into networked device systems for the localization of objects. In accordance with some embodiments of the invention, a networked device system incorporates a collection of various local network devices and/or remote computing devices that may exchange various feedback, information, instructions, and/or related data (e.g. an MPS). Unlike other location-based technologies, processes in accordance with some embodiments of the invention can incorporate ultra-wideband transmissions in order to extract channel impulse response from the signal reflections in a given area. Processes in accordance with some embodiments of the invention may be performed by a receiver device, an external controller device, a cloud server, and/or by consumer-grade hardware to invoke multi-static radar capabilities. Some processes may be used to pinpoint a change in the environment in which the process is performed. An environment may also be referred to as an area of operation in this description. A change in the environment may include, but is not limited to, a newly introduced object, a movement of a frame of reference, a movement of an existing object, or a change in the position of a receiver or broadcast node.

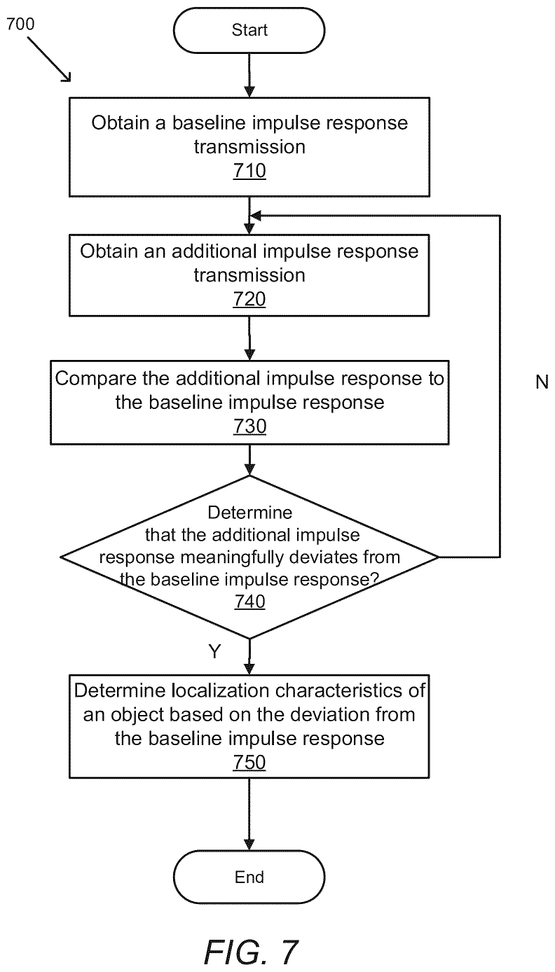

An example of a process for UWB multi-static systems in accordance with some embodiments of the invention is conceptually illustrated in FIG. 7. Process 700 obtains (710) a baseline impulse response from a receiver device, upon receiving a signal transmitted from a broadcast device. Systems operating in accordance with some embodiments of the invention may include one or more UWB nodes located at various points in an area of operation in proximity to the broadcast device. In some embodiments of the invention, UWB nodes can be placed in various static locations within the area of operation including, but not limited to, floors, ceilings, and walls in the area of operation. In accordance with a number of embodiments, static locations may be free-standing and/or placed on furniture. In some embodiments, baseline impulse responses may establish a point of reference for the system. In some embodiments of the invention, baseline impulse responses may be based off of a single baseline signal at one point in time. In a number of embodiments of the invention, a baseline impulse response may be established through an impulse response corresponding to an average of a rolling buffer. In various embodiments of the invention, a baseline impulse response may be based off of an average over a preset period of time. For example, a baseline impulse response may be based on the average impulse response in the area of operation from the hours of 6:00 am to 7:00 am. Systems operating in accordance with some embodiments of the invention may interpret a baseline impulse response as reflective of the system in an inactive state for a given period.

Process 700 can obtain (720) an additional impulse response from the receiver device, upon receiving an additional signal transmitted from the broadcast device. In accordance with some embodiments of the invention, a channel between a first UWB node and a second UWB node will be the channel between the second UWB node and the first UWB node. As such, a single transmission, regardless of direction, between the first and second UWB nodes can establish a baseline impulse response for either the first UWB or the second UWB node. In accordance with some embodiments of the invention, a UWB node may function as a receiver and/or a broadcast device. Alternatively, external hardware capable of communicating with broadcast and/or receiver devices operating in accordance with some embodiments of the invention can be incorporated into systems, providing additional receiver and/or broadcast devices capable of refining localization of one or more objects. Processes operated through an external controller device and/or cloud servers may also obtain baseline impulse responses and additional impulse responses obtained from a transmission from the broadcast device to a plurality of nodes.

Given the baseline impulse response and the additional impulse response obtained from the receiver device, process 700 can compare (730) the additional impulse response to the baseline impulse response. In comparing baseline impulse responses to additional impulse responses, processes in accordance with some embodiments of the invention may utilize Channel Impulse Response (CIR) measurements to assess the impulse responses.

In accordance with some embodiments of the invention, processes may operate under the assumption that an introduction of an object into the area of operation can create a disturbance in the features of CIR measurements. Through the assessment of an additional impulse response in accordance with some embodiments of the invention, process 700 may determine (740) the extent to which the additional impulse response meaningfully deviates from the baseline impulse response. A deviation may also be referred to as a disturbance or perturbation in this description. The determination of a meaningful deviation may be determined from excess over a predetermined threshold. A deviation determined to be non-meaningful may be classified as negligible.

If process 700 determines (740) that the additional impulse response does not meaningfully deviate from the baseline impulse response, the process returns to step 720 and continues to obtain impulse responses. In this case, process 700 may determine that there is no substantive change in the area of operation if there is no disturbance in the features reflected in CIR measurements. For systems operating in accordance with some embodiments of the invention and operating with a plurality of nodes and/or external hardware, if process 700 finds that there is no disturbance in the features of the CIR measurement for every node in the area of operation, process 700 may determine that no new objects have entered the networked device system. For a networked device system operating in accordance with a number of embodiments of the invention and operating with a plurality of nodes, if the process 700 finds that there is a disturbance in the features of the CIR measurement for one or more pairs of nodes in the area of operation, the process may determine that one or more changes has occurred in the networked device system.

If process 700 determines (740) that the additional impulse response does meaningfully deviate from the baseline impulse response, the process determines (750) localization data for a change in the environment based on the deviation from the baseline impulse response. Localization data can be data reflective of a change in the environment including, but not limited to, the presence and/or movement of an object (e.g. people walking through a space) in the environment. The presence and/or movement of an object may be indicated by, but is not limited to, an obstruction between the broadcast and receiver devices.

While specific processes for localization are described above, any of a variety of processes can be utilized as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

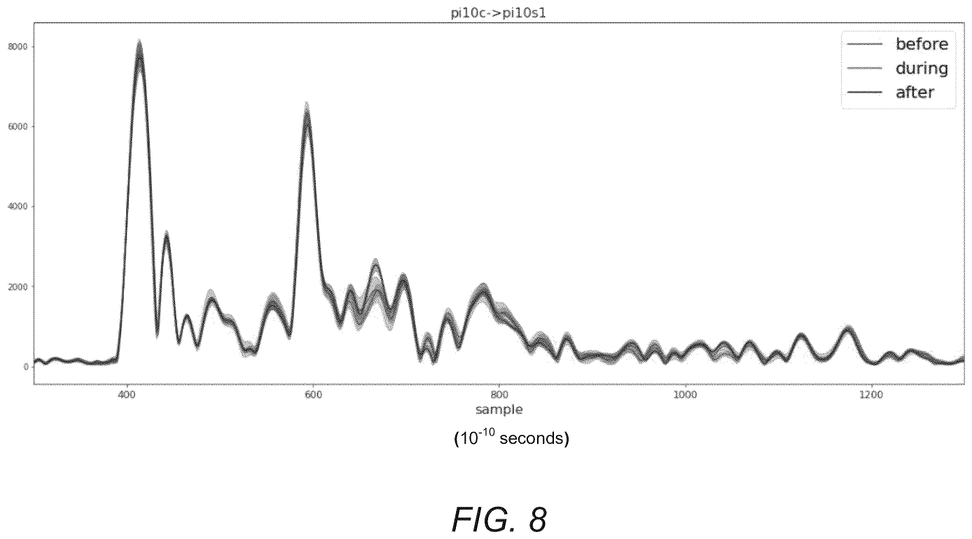

Systems and processes in accordance with a number of embodiments are directed to producing a plurality of impulse responses within an area of operation over a period of time preceding and following a change in the environment. FIG. 8 illustrates impulse responses within a sample area of operation over three separate periods. The corresponding CIR measurements reflect the channel impulse response from a signal transmitted from a broadcast device to a receiver device, wherein the signal is first received by the receiver device at 40 nanoseconds. The three colors of the graph reflect signals transmitted over three different periods. The series of samples reflective of a signal transmitted before an object's introduction into the area of operation (red) may correspond to a possible baseline impulse response. In the example depicted in FIG. 8, roughly 1300 samples are used, with a transmission every 10 nanoseconds. In various embodiments of the invention, the sample size for transmissions include, but are not limited to 2, 10, 100, 1,000, 10,000, and 100,000. The series of samples reflective of a signal transmitted during the object's introduction into the area of operation (green) may be a possible additional impulse response, wherein systems operating in accordance with some embodiments of the invention may determine a deviation from the aforementioned possible baseline impulse response. The series of samples reflective of a signal transmitted after the object's introduction into the area of operation (blue) may depict another possible baseline impulse response, reflecting the updated state of the area of operation. In accordance with some embodiments of the invention, the curve of the CIR measurement may reflect a stable impulse response over various signal broadcasts so long as the area of operation remains constant or stable. The green curve in FIG. 8 reflects an example of a disturbance in the features of the CIR measurements at a series of points representative of roughly 50 nanoseconds after the first arrival of a signal at the receiver from a transmitted broadcast. The disturbance in the features of the CIR measurements may suggest a reflection of the signal after bouncing off of a disturbance, but before reaching the receiver device.

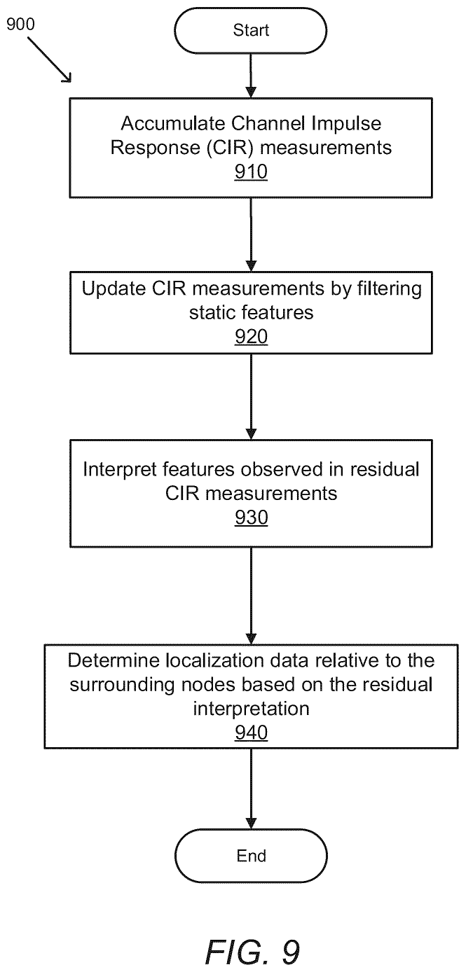

Through interpreting CIR measurements in an area of operation, systems in accordance with the invention can pinpoint entities that enter said area. An example of a process for interpreting CIR measurements in order to localize an object in an area of operation in accordance with an embodiment is conceptually illustrated in FIG. 9. Process 900 accumulates (910) channel impulse response measurements in a raw form that can be utilized to derive a baseline impulse response. At least one additional impulse response is also accumulated that can be utilized to detect the presence of one or more objects within the environment. In several embodiments, the additional measurements can also be utilized to localize and/or determine motion of the one or more objects. In some embodiments of the invention, the accumulated CIR measurements may reflect a plurality of additional impulse responses, each obtained after a baseline impulse response is determined. In some embodiments of the invention, the CIR measurements may reflect data obtained from a plurality of receivers. In some embodiments of the invention, the channel impulse response measurements corresponding to the plurality of receivers may reflect CIR magnitude measurements as a function of distance and/or time of receipt for the plurality of additional impulse responses.

Process 900 can update (920) CIR measurements by filtering static features from said measurements. The filtering of static features from CIR measurements may include extracting the baseline impulse response from the accumulation of channel impulse response measurements. Filtering methods may incorporate, but are not limited to, Kalman Filtering, Importance Sampling, Simulated Annealing, Genetic Optimization, Particle Filtering, and/or Unscented Transforms.

In some embodiments of the invention, static features may refer to signal reflections associated with the area of operation at the time of the baseline impulse response including, but not limited to, signal reflections from walls, floors, and furniture. In some embodiments, baseline impulse responses may be derived from static features measured at a over a specific period of time. A baseline impulse response may be used to approximate an impulse response to the area of operation at rest. Static features may also be filtered out, through filtering baseline impulse responses out of CIR measurements, to generate residual CIR measurements. Updating CIR measurements by filtering static features may increase the likelihood that perturbations in the residual CIR measurements are more detectable. In accordance with some embodiments of the invention, perturbations in the residual CIR measurements may be interpreted as resulting from the change in the environment. As such, residual CIR measurements may be inferred to suggest a change in the environment. The remaining data remaining upon the extraction of the baseline impulse responses may be referred to as the “residual features” or “residuals” in this description.

Process 900 can interpret (930) features observed in residual CIR measurements as a function of distance and/or time. In the residual CIR measurements, the distance may represent the distance (relative to a direct transmission from a given broadcast device to a given receiver device) that reflected signals may need to travel to be received at the receiver device. Distance in CIR measurements may be considered proportional to the sum of the actual (real-world) distance between the location of the change in the environment and a given broadcast device, and the actual distance between the location of the change in the environment and a given receiver device. As such, in accordance with some embodiments of the invention, the change in the environment may produce a reflected signal that suggests a change in distance value. In this context, time may represent the period encompassing, but not limited to, the period of any given change in the environment encompassing the area of operation. Through interpreting said residuals, process 900 can determine (940) localization data relative to the surrounding nodes based on residual interpretation. Examples of determining localization data are referenced throughout the disclosure.

While specific processes for localization are described above, any of a variety of processes can be utilized as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

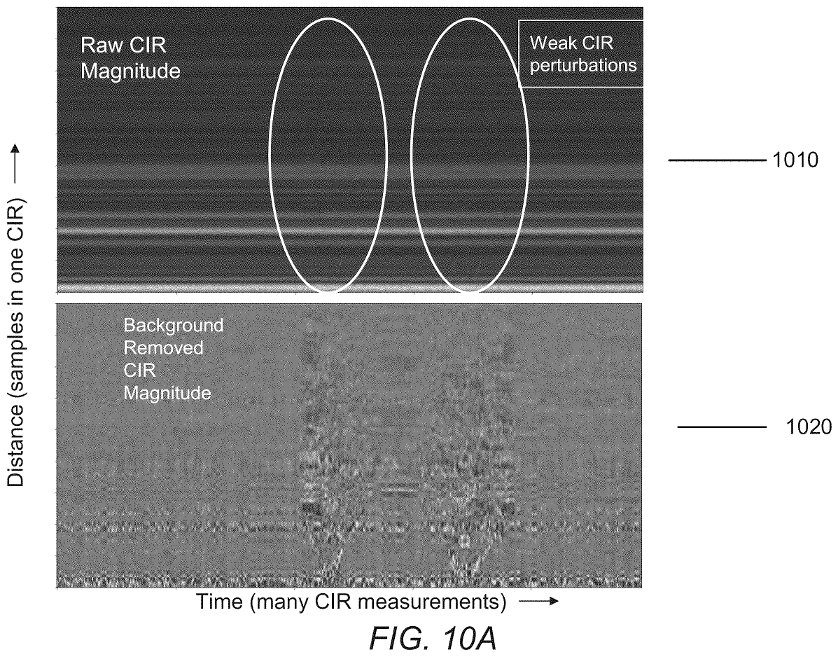

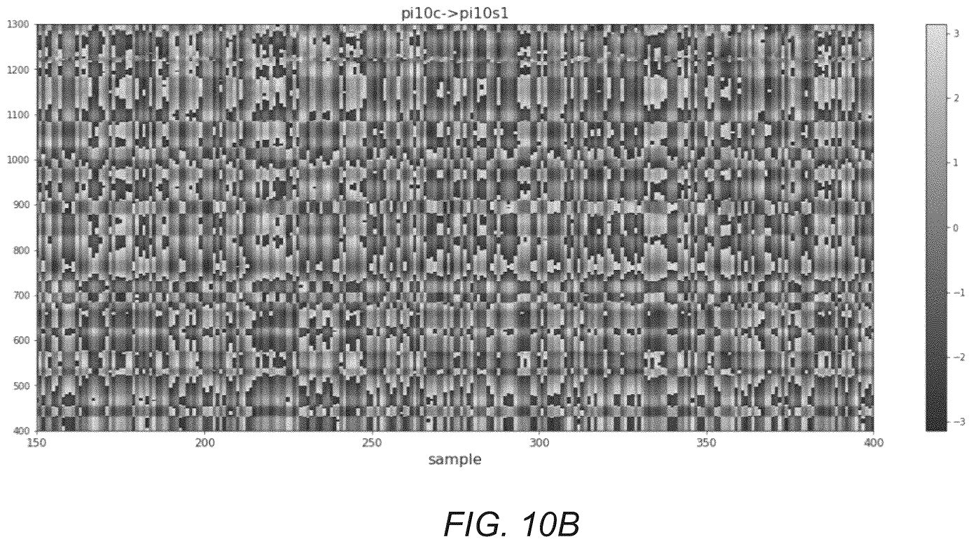

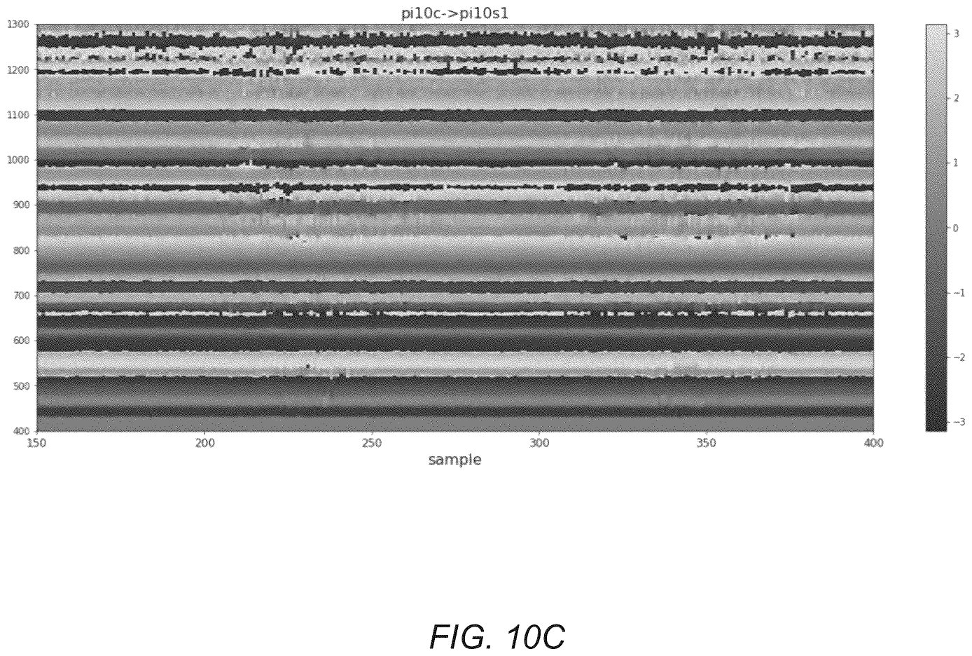

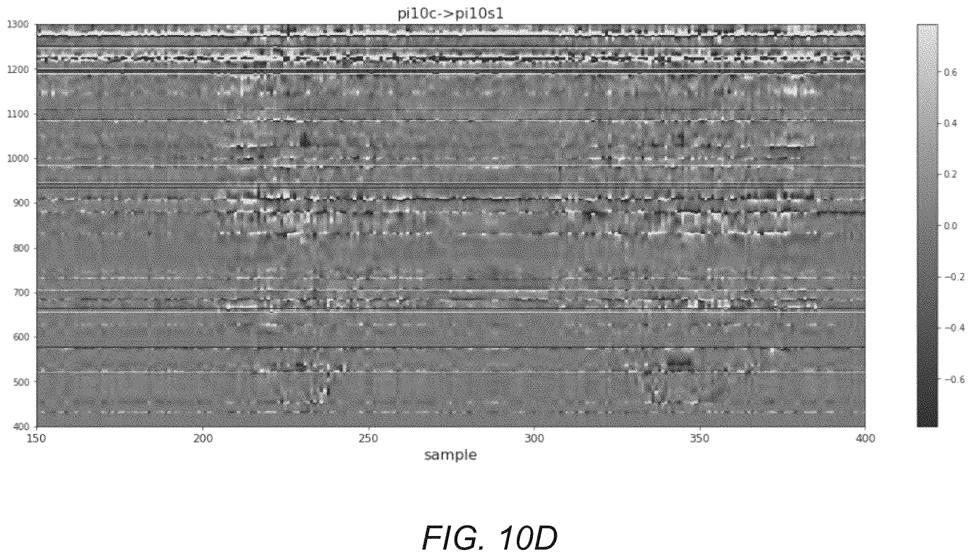

Many embodiments of the invention are able to clarify CIR measurements through filtering static signals from raw CIR measurements. FIG. 10A illustrates an example of the impact that the filtering of static signals from raw CIR measurements 1010 can have on resulting residual CIR measurements 1020. Residual CIR measurements 1020 may also be referred to as “Background-Removed CIR Magnitude” measurements or BRCIRM measurements in this description. As evidenced in FIG. 10A, raw CIR measurements 1010, for systems incorporating multiple additional impulse responses, can have perturbations that are overshadowed by baseline impulse responses. Filtering static features may provide more detectable perturbations, which may support interpreting features observed in residual CIR measurements 1020.

Some embodiments of the invention are able to localize changes in the environment through filtering static signals from raw CIR phase measurements, rather than or in combination with magnitude measurements. FIG. 10B illustrates an example of a phase spectrogram produced by a receiver device in response to a signal transmission. FIG. 10C illustrates the measurement of FIG. 10B after a phase alignment, shifting the representation of a signal to align its critical points. In some embodiments, this change may allow disturbances to be more easily measurable. FIG. 10D illustrates FIG. 10C after the static features have been filtered out, maximizing the perceptibility of the detected disturbance. CIR phase measurements, in accordance with many embodiments of the invention may alternatively be interpreted alone, alongside CIR magnitude measurements, or not at all.

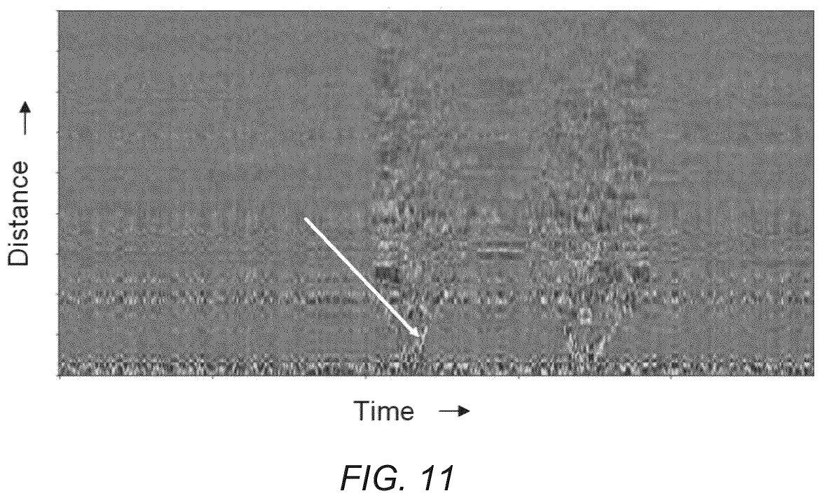

Many embodiments of the invention may utilize one or more residual CIR measurements in deriving the position of the change in the environment. FIG. 11 illustrates an example of mapping a residual CIR measurement. A white arrow overlaid on the figure identifies a first disturbance of the BRCIRM measurement, identifying a position relative to the two nodes. Interpretation of BRCIRM measurements in accordance with many embodiments of the invention may be performed relative to (the midpoint of) a pair of UWB nodes: a broadcast device and a receiver device, respectively. For example, perturbations following a line suggesting a decrease in distance and an increase in time may suggest an object moving towards the midpoint of the UWB nodes. Conversely, perturbations suggesting an increase in distance and an increase in time, as is the case in the perturbation pointed to in FIG. 11, may suggest movement away from the midpoint of the UWB nodes.

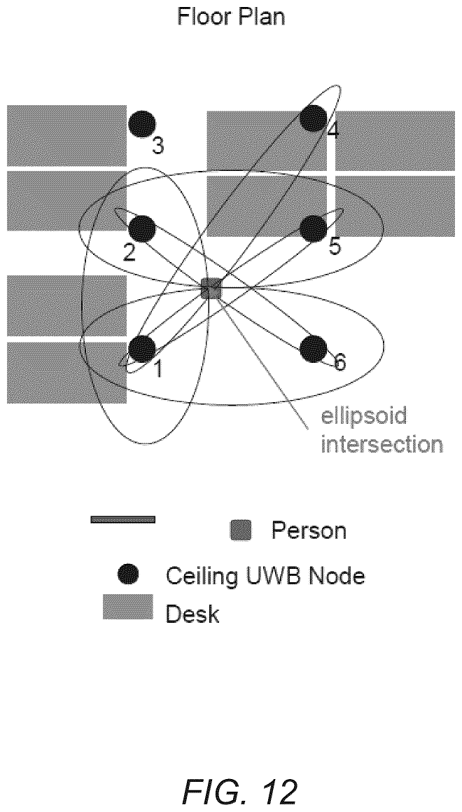

Some embodiments of the invention may use a specific configuration of UWB nodes to localize a change in the environment. In some embodiments, the basis for a given configuration may be knowledge of the distance between each pair of UWB nodes. FIG. 12 depicts an example of an area of operation incorporating multiple UWB nodes. Within the area of operation are six UWB nodes, wherein each pairing of nodes is associated with an ellipsoid (for which, each node is a focus point). Each hypothetical ellipsoid may represent a surface of ambiguity that represents the series of points, at a specific distance, which estimates the location of a change in the environment. The specific distance may be estimated through the use of BRCIRM measurements for three pairs of nodes, allowing the narrowing down of the object's localization to a singular point where the boundaries of the corresponding hypothetical ellipsoids overlap in three-dimensional space. In an arrangement analogous to that represented in FIG. 12, there may be 30 different overlapping hypothetical ellipsoids, each of which may represent BRCIRM measurements that can be used to further localize the change in the environment.

Although a specific example of a node configuration is illustrated in FIG. 12, any number or arrangement can be utilized to perform localization processes similar to those described herein as appropriate to the requirements of specific applications in accordance with embodiments.

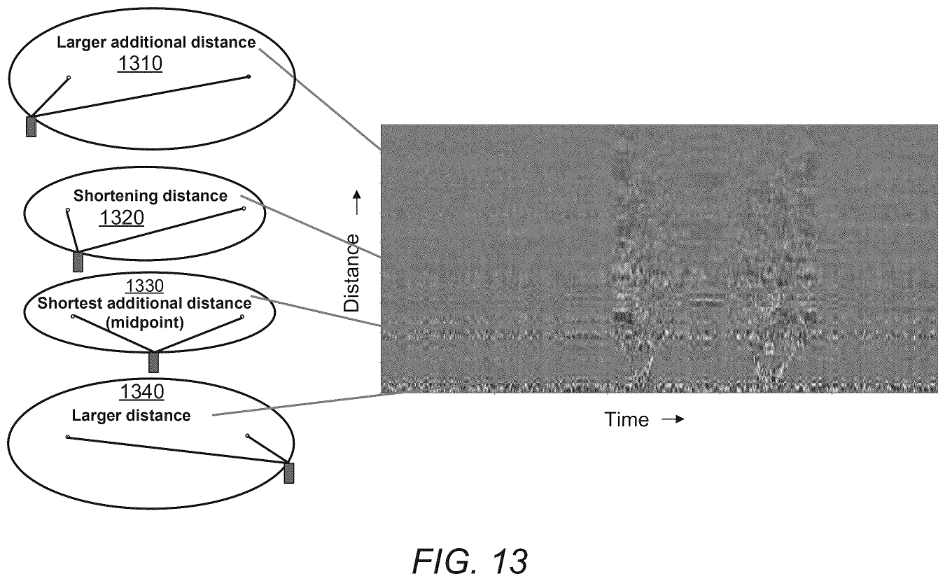

In a number of embodiments of the invention, a change in the environment can map to the perturbations observed in BRCIRM measurements. FIG. 13 depicts an example that localizes a moving object into a particular surface of ambiguity, reinforcing that points within the corresponding surface of ambiguity may be reflected in BRCIRM measurements. A position reflective of a large distance 1310, 1340 for a hypothetic ellipsoid may illustrate a change within a larger surface of ambiguity. The corresponding BRCIRM measurements for an object at this series of points on the hypothetical ellipsoid may have CIR perturbations (indicative of a spike in CIR magnitude) with a substantially greater distance value. A given distance value may be identified on a BRCIRM measurement via the point at which there is a substantial disturbance in the CIR magnitude measurement (i.e. a perturbation).

In a number of embodiments of the invention, specific movement relative to a given configuration of nodes may be reflected in the observed BRCIRM measurements. As an object's distance from the nodes shortens 1320 and an object's distance approaches its minimum (e.g. the midpoint 1330 of the nodes), the distance values of the BRCIRM perturbations may reach their minimum as well. Therefore, in many embodiments of the invention, an area of operation in which many surfaces of ambiguity overlap may benefit from the respective BRCIRM measurements for each ellipsoid in order to identify a given object's distance values (relative to multiple nodes).

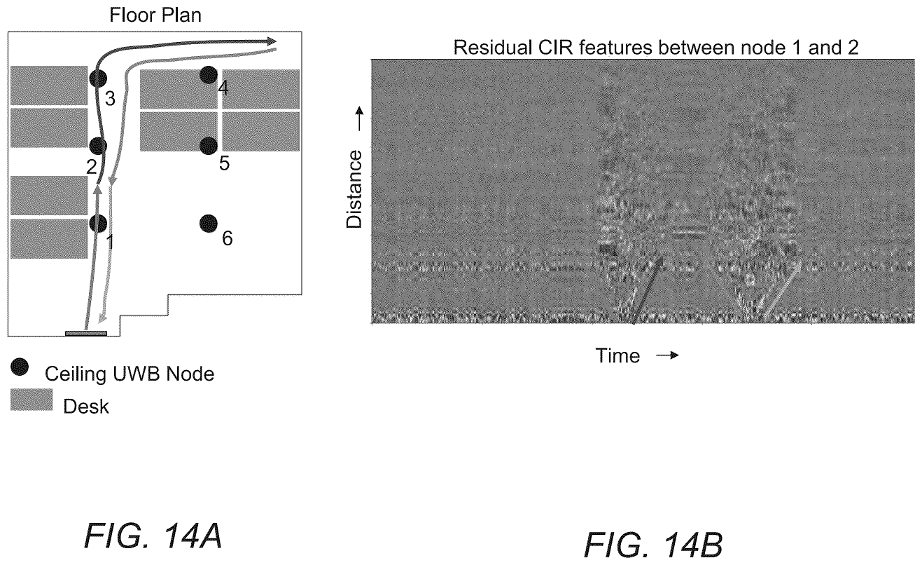

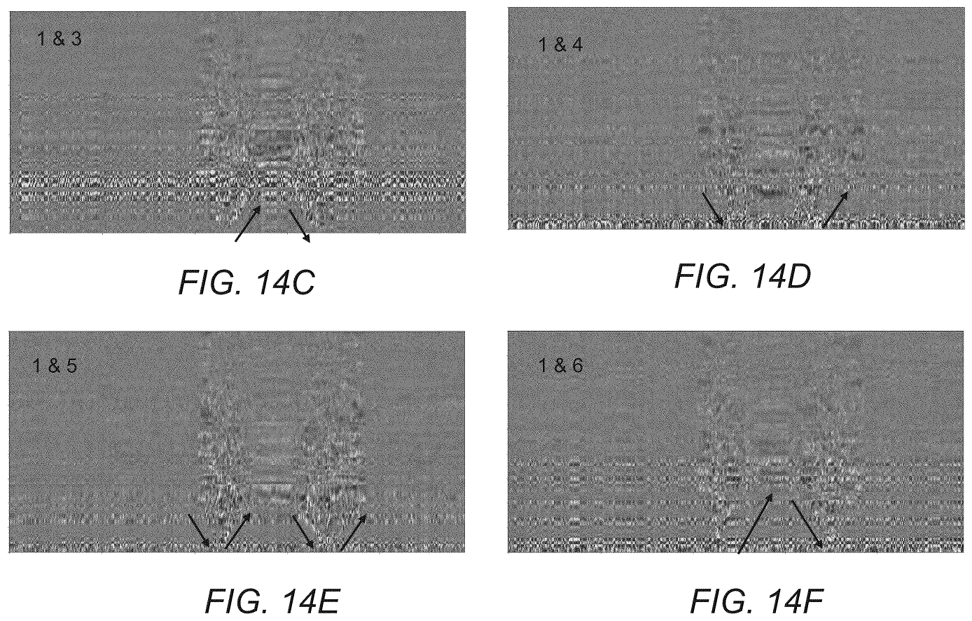

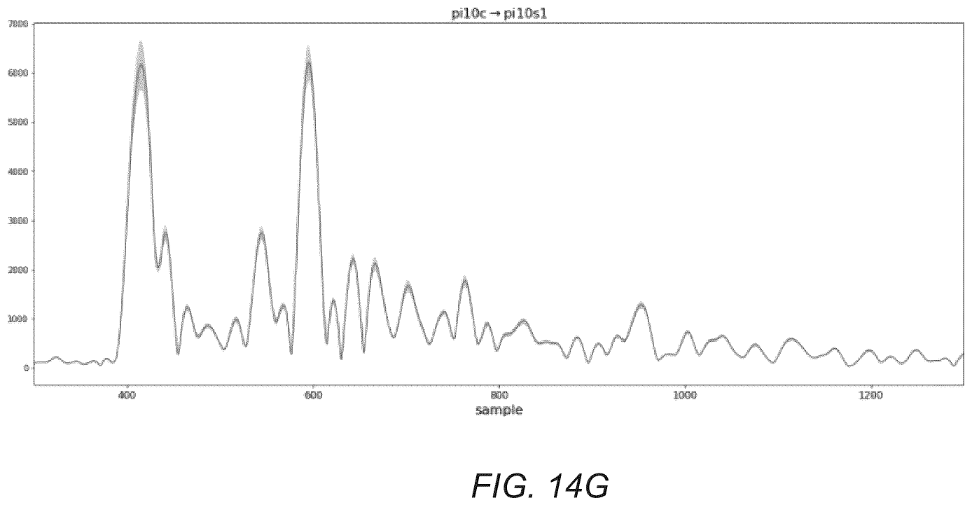

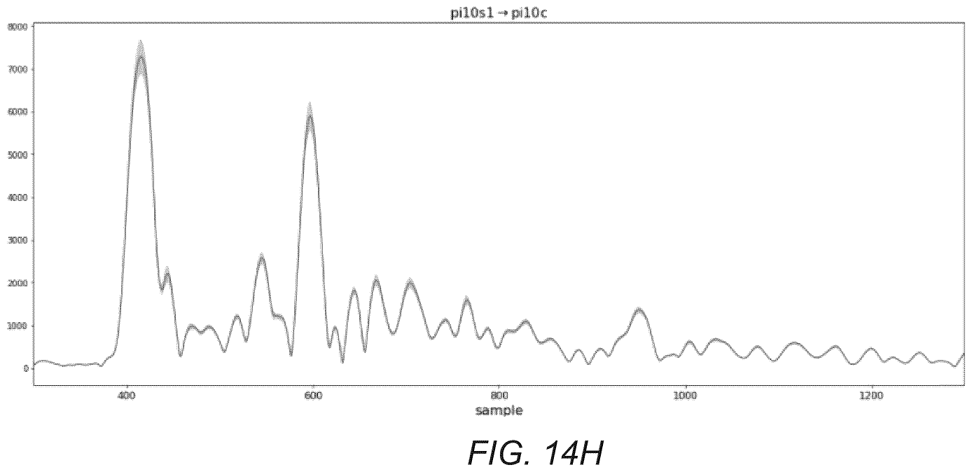

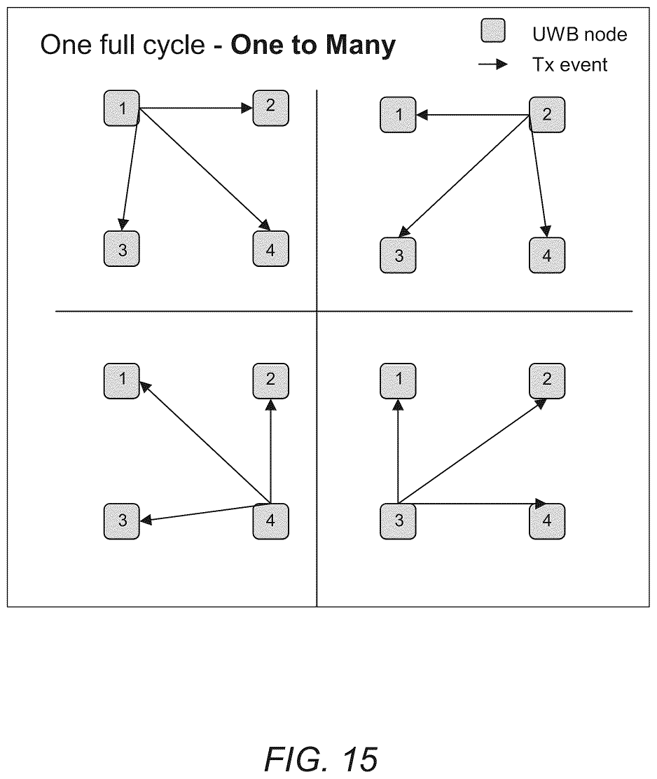

Some embodiments of the invention may use a series of UWB nodes to localize a change in the environment. FIG. 14A discloses a sample floorplan, incorporating six different nodes, for an area operating in accordance with aspects of the disclosure. A sample object's movement through the area at different points is represented by a series of colored arrows. FIG. 14B depicts a corresponding BRCIRM measurement for the area disclosed in FIG. 14A. In FIG. 14B, superimposed arrows, with corresponding colors to FIG. 14A, depict respective inferences of the object's distance relative to nodes 1 and 2 of FIG. 14A. Although a specific example of a node configuration is illustrated in FIG. 14A, any number or arrangement of nodes can be utilized to perform localization processes similar to those described herein as appropriate to the requirements of specific applications in accordance with embodiments. In many embodiments of the invention, multiple combinations of nodes may each have corresponding BRCIRM measurements and be used to further localize a given object. In some embodiments, any of the nodes may operate as a transmitter, allowing each node to obtain CIR measurements for each possible pairing.

FIGS. 14C-14F depict corresponding BRCIRM measurements for multiple other combinations of nodes alongside respective inferences of distance. In some embodiments, a channel between a first UWB node and a second UWB node will also be the channel between the second UWB node and the first UWB node. A single transmission, regardless of direction, between the first and second UWB nodes may establish a baseline impulse response for either the first UWB or the second UWB node.

FIGS. 14G and 14H depict CIR measurements for a single transmission between two nodes. Specifically, FIG. 14G shows the CIR measurement from node 1 for a transmission from node 1 to node 2, while FIG. 14H shows the CIR measurement for that same transmission from node 2 to node 1. For CIR measurements in accordance with many embodiments of the invention, the symmetry in measurement for the two nodes can be utilized to assess the validity of a given node's sensors. In some embodiments, a defect in one of the nodes is determined in response to detection of an asymmetrical pairing wherein a transmission from a first node to a second node does not produce a pair of matching CIR measurements from each node.

Performing processes, in accordance with many embodiments of the invention, by incorporating a plurality of UWB nodes may allow for an increase in time resolution. FIG. 15 illustrates a substantial advantage of the use of a one-to-many configuration of UWB nodes for an area of operation. First, the configuration limits the number of transmissions needed for the localization of a given object. The transfer of data disclosed in FIG. 15 corresponds to the information discoverable upon a single signal transmission. As such, in accordance with many embodiments of the invention, each node can successfully recover reflection observations from the signal transmission. This can enable the collection of multiple CIR magnitude measurements and the construction of an area of operation with multiple overlapping surfaces of ambiguity. Finally, this arrangement ensures that CIR measurements, in accordance with many embodiments of the invention, can be based upon simultaneous CIR measurements.

Although a specific example of a node configuration is illustrated in FIG. 15, any number or arrangement can be utilized to perform localization processes similar to those described herein as appropriate to the requirements of specific applications in accordance with embodiments.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Further, the examples described herein may be employed in systems separate and apart from media playback systems such as any Internet of Things (IoT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example loT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These loT systems may also include one or more devices that communicate with the loT device via one or more networks such as one or more cloud servers (e.g., that communicate with the loT device over a WAN) and/or one or more computing devices (e.g., that communicate with the loT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A localization method, comprising:
determining a baseline impulse response from transmission of at least one baseline signal;
determining at least one Channel Impulse Response (CIR) measurement from transmission of an additional signal;
obtaining at least one residual CIR measurement based upon the baseline impulse response and the at least one CIR measurement;
evaluating the at least one residual CIR measurement to detect a change within an area of operation; and
after the change is detected within the area of operation, determining a location at which the change in the area of operation occurred.

2. The localization method of claim 1, wherein the at least one baseline signal is transmitted from a broadcast device to one or more receiver devices within the area of operation.

3. The localization method of claim 2, wherein the additional signal is transmitted from the broadcast device to the one or more receiver devices within the area of operation.

4. The localization method of claim 3, wherein determining the at least one CIR measurement comprises receiving at least one additional impulse response from a set of at least one of the one or more receiver devices.

5. The localization method of claim 1, wherein detecting the change in the area of operation comprises:
detecting a deviation;
determining whether a magnitude of the deviation exceeds a specific threshold; and
classifying the deviation as indicative of the change in the area of operation when the deviation exceeds the specific threshold.

6. The localization method of claim 1, wherein a process to obtain the at least one residual CIR measurement is selected from the group consisting of Kalman Filtering, Importance Sampling, Simulated Annealing, Genetic Optimization, Particle Filtering, and Unscented Transforms.

7. The localization method of claim 1, wherein determining the at least one CIR measurement from the transmission of the additional signal comprises deriving the at least one CIR measurement from an impulse response corresponding to the transmission of the additional signal, and the at least one CIR measurement is selected from the group consisting of an amplitude of the impulse response and a phase of the impulse response.

8. The localization method of claim 2, wherein the broadcast device and each of the one or more receiver devices are playback devices.

9. The localization method of claim 1, wherein the transmissions are ultra-wideband transmissions.

10. The localization method of claim 1, wherein determining the baseline impulse response comprises determining the baseline impulse response from a plurality of baseline transmissions.

11. (canceled)

12. The localization method of claim 2,
wherein the additional signal is a first signal from the broadcast device to the one or more receiver devices and the at least one CIR measurement is a first CIR measurement, and
wherein the localization method further comprises validating the at least one CIR measurement by:
transmitting a second signal from a receiver device of the one or more receiver devices to the broadcast device;
producing a second CIR measurement from the second signal;
comparing the first CIR measurement to the second CIR measurement; and
validating the first CIR measurement based on the comparison.

13. The localization method of claim 1, wherein determining the location at which the change in the area of operation occurred comprises:
determining, by a first device, based on the residual CIR measurement, a first estimated distance to the change detected within the area of operation,
determining, by a second device, a second estimated distance to the change detected within the area of operation; and
based on at least the first and second estimated distances, determining the location at which the change in the area of operation occurred.

14. The method of claim 13, wherein determining the location at which the change in the area of operation occurred comprises determining the location based on a known distance between the first and second devices.

15. A non-transitory, computer-readable medium comprising instructions that, when executed, are configured to cause a processor of an ultra-wideband multi-static radar controller within the area of operation to perform the method of one of claims 1 to 10 or claims 12 to 14.

16. An ultra-wideband multi-static radar system, the system comprising:
a broadcast device within an area of operation;
one or more receiver devices within the area of operation; and
an external controller, comprising:
a processor;
memory accessible by the processor; and
instructions stored in the memory that, when read by the processor, direct the processor to
determine a baseline impulse response from transmission of at least one baseline signal,
determine at least one Channel Impulse Response (CIR) measurement from transmission of an additional signal transmission,
obtain at least one residual CIR measurement based upon the baseline impulse response and the at least one CIR measurement,
evaluate the at least one residual CIR measurement to detect a change within the area of operation, and
after the change is detected within the area of operation, determine a location at which the change in the area of operation occurred.

17. The ultra-wideband multi-static radar system of claim 16, wherein the at least one baseline signal is transmitted from a broadcast device to at least one receiver device within the area of operation;
wherein the additional signal is transmitted from the broadcast device to the at least one receiver device within the area of operation; and
wherein determining the at least one CIR measurement comprises receiving at least one additional impulse response from a set of one or more of the at least one receiver devices.

18. The ultra-wideband multi-static radar system of claim 17, wherein the broadcast device can also receive signals and the receiver device can also broadcast signals;
wherein the additional signal is a first signal from the broadcast device to the receiver device and the at least one CIR measurement is a first CIR measurement; and
wherein the instructions further comprise instructions that, when read by the processor, direct the processor to validate the at least one CIR measurement by:
causing transmission of a second signal from the receiver device to the broadcast device,
producing a second CIR measurement from the second signal,
comparing the first CIR measurement to the second CIR measurement, and
validating the first CIR measurement based on the comparison.

19. The ultra-wideband multi-static radar system of claim 17, wherein the broadcast device and each of the at least one receiver devices are playback devices; and
wherein the transmissions are ultra-wideband transmissions.

20. The ultra-wideband multi-static radar system of claim 16, wherein detecting change in the area of operation comprises:
detecting a deviation;
determining whether a magnitude of the deviation exceeds a specific threshold; and
classifying the deviation as indicative of change in the area of operation when the deviation exceeds the specific threshold.

21. The ultra-wideband multi-static radar system of claim 16, wherein CIR measurements for a signal transmission are derived from an impulse response corresponding to the signal transmission, and the CIR measurement is selected from the group consisting of an amplitude of the impulse response and a phase of the impulse response.
